(19) United States
(12) Patent Application Publication
(10) Pub. No.: US 2023/0179744 A1
(43) Pub. Date: Jun. 8, 2023

(54) CHILD CAR SEAT TRACKING SYSTEM

(71) Applicant: INNOVATIVE AFTERMARKET GROUP, CHANDLER, AZ (US)

(72) Inventors: Carl Anthony Avila, Phoenix, AZ (US); Satya Vamshi Pattela, Tempe, AZ (US)

(21) Appl. No.: 17/933,831

(22) Filed: Sep. 20, 2022

Related U.S. Application Data
(60) Provisional application No. 63/261,378, filed on Sep. 20, 2021.

(51) Int. Cl. H04N 7/18; B60N 2/00; B60R 1/29

(52) U.S. Cl. CPC H04N 7/188; B60N 2/002; B60R 1/29; B60N 2/26

(57) ABSTRACT

A system for tracking whether a child has been left in a child's car seat includes a child seat sensing device with s proximity sensor that can sense a child's presence in the car seat. The seat sensing device can communicate with a GPS tracker in the vehicle, which can communicate with a camera onboard the vehicle. The seat sensing device is configured so that if the proximity sensor senses a child's presence in the car seat when the vehicle ignition is off, the seat sensing device will send an alert signal to the GPS tracker. In response to the alert signal, the GPS tracker is configured to cause the camera to send an alert to a user, capture an image of the car seat in the vehicle, and send the image to the user.

### RELATED APPLICATION

This patent application claims the benefit of U.S. Provisional Application No. 63/261,378, filed Sep. 20, 2021 entitled “CHILD CAR SEAT TRACKING SYSTEM,” which is incorporated herein in its entirety by this reference.

### BACKGROUND

This invention relates to child car seats. More particularly, it relates to a system for tracking a child car seat that can sense whether a child has been left in a vehicle after the vehicle ignition is turned off and can notify the parent or other user of the system accordingly.

It is an object of the present invention to provide such a system. Additional objects and advantages of the invention will be set forth in the description that follows, and in part will be apparent from the description, or may be learned by practice of the invention. The objects and advantages of the invention may be realized and obtained by means of the instrumentalities and combinations pointed out in the appended claims.

### SUMMARY

To achieve the foregoing objects, and in accordance with the purposes of the invention as embodied and broadly described in this document, there is provided a system for tracking whether a child has been left in vehicle in a child's car seat. The system includes a child seat sensing device (i.e., a seat sensing device) having at least one proximity sensor that can sense a child's presence in the car seat. The seat sensing device can communicate with a GPS tracker in the vehicle, which can communicate with a camera onboard the vehicle. The seat sensing device is configured so that if the proximity sensor senses a child's presence in the car seat when the vehicle ignition is off, the seat sensing device will send an alert signal to the GPS tracker. The GPS tracker is configured to cause the camera to capture an image of the car seat in the vehicle in response to the alert signal and to send the image to the user.

In some embodiments, the proximity sensor can be configured to detect whether a car seat buckle is fastened.

In some embodiments, the GPS tracker can communicate wirelessly with a second tracking device in addition to the seat sensing device, wherein the second tracking device is in the possession of a driver of the vehicle or other user of the system.

### BRIEF DESCRIPTION OF THE DRAWINGS

The accompanying drawings, which are incorporated in and constitute a part of the specification, illustrate the presently preferred embodiments of the invention and, together with the general description given above and the detailed description of the preferred methods and embodiments given below, serve to explain the principles of the invention.

FIG. 1 is a block diagram of the components of one embodiment of a tracking system for use with the child car seat in accordance with the present invention, including a seat sensing device that includes a proximity sensor.

FIG. 2 is a block diagram of another embodiment of a tracking system according to the present invention, which includes a secondary tracker device in possession of a user in addition to the seat sensing device.

FIG. 3 is a block diagram of the tracking system of FIG. 1, which diagram also includes a logical flow chart depicting operation of the system.

FIG. 4 is a block diagram of the tracking system of FIG. 2, which also includes a logical flow chart depicting operation of the system.

### DETAILED DESCRIPTION

Reference will now be made in more detail to presently preferred embodiments of the invention, as illustrated in the accompanying drawings. While the invention is described more fully with reference to these examples and drawings, the invention in its broader aspects is not limited to the specific details, representative devices, and illustrative examples shown and described. Rather, the description which follows is to be understood as a broad, teaching disclosure directed to persons of ordinary skill in the appropriate arts, and not as limiting upon the invention.

For simplicity and clarity of illustration, the drawing figures illustrate the general manner of construction, and description and details of well-known features and techniques may be omitted to avoid unnecessarily obscuring the invention. Additionally, elements in the drawing figures are not necessarily drawn to scale, some areas or elements may be expanded to help improve understanding of embodiments of the invention.

The terms “first,” “second,” “third,” “fourth,” and the like in the description and the claims, if any, may be used for distinguishing between similar elements and not necessarily for describing a particular sequential or chronological order. It is to be understood that the terms so used are interchangeable. Furthermore, the terms “comprise,” “include,” “have,” and any variations thereof, are intended to cover non-exclusive inclusions, such that a process, method, article, apparatus, or composition that comprises a list of elements is not necessarily limited to those elements, but may include other elements not expressly listed or inherent to such process, method, article, apparatus, or composition.

The present application discloses a system that includes a child car seat with an attached Bluetooth tracker or tag and one or more proximity sensors (e.g., optical or infrared sensors or reed switches) that can check for a child's presence in the seat.

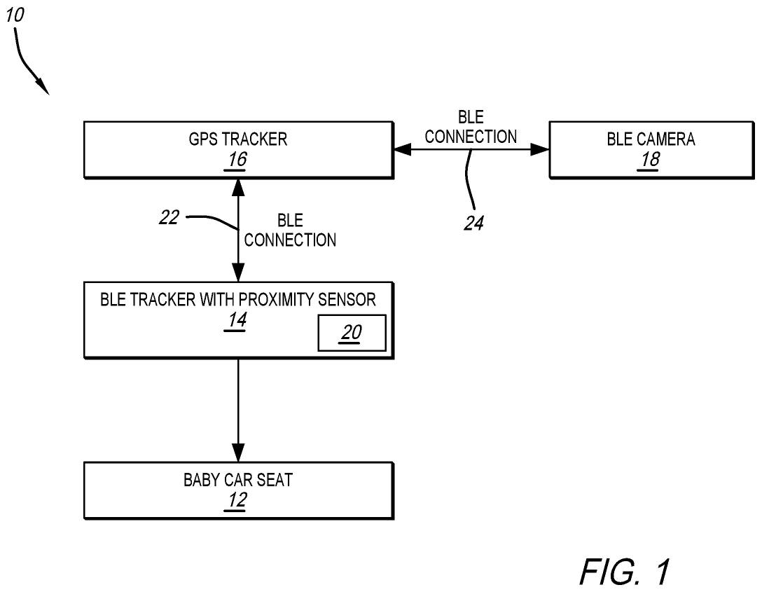

Referring to FIG. 1, a presently preferred embodiment of a system 10 for tracking a child car seat 12 according to the present invention includes a seat sensing device 14 that is equipped with one or more proximity sensors 20. The seat sensing device 14 can communicate wirelessly with a vehicle onboard GPS tracker 16, which can communicate with a vehicle onboard camera 18. The seat sensing device 14 also includes a Bluetooth tracker or tag (also referred to as a key finder or smart tracker), which is a small electronic device that allows a user to monitor the location of an item to which it is attached. A Bluetooth tracker uses a Bluetooth low energy (also known as BLE or Bluetooth 4.0) chip to wirelessly connect to another Bluetooth-enabled device and transmit data to that device through the wireless connection. The GPS tracker 16 also has a BLE chip so that it can communicate with the seat sensing device 14 on the child seat 12 and also with the onboard camera 18 in the vehicle that has Bluetooth functionality.

Still referring to FIG. 1, the proximity sensors 20 can sense the child's presence in the car seat 12. A proximity sensor is a sensor that can detect the presence of nearby objects without any physical contact. In some embodiment, the proximity sensors can, for example, be optical proximity sensors. An optical proximity sensor is a device that uses the principle of triangulation of reflected infrared or visible light to measure small distances in robotic systems. Such sensors can be utilized to check for the child's presence in the car seat 12 by measuring the distance from the sensor to the child and calibrating that distance to avoid false positive readings.

In some embodiments, the proximity sensors 20 can include one or more reed switches to determine whether a buckle of the car seat 12 has been unfastened. A reed switch is an electrical switch operated by an applied magnetic field. Reed switches and reed sensors can be used for proximity sensing and can be activated by a magnet. As the magnet is brought into the proximity of the reed sensor/switch, the device activates. When used with reed switches, the seat sensing device 14 can be attached to the child car seat buckle and the proximity sensor 20 can be activated when the buckle is fastened. The reed switch can include a BLE module to communicate with the Bluetooth on the GPS tracker 16 and can be powered by a small battery. In such an embodiment, the proximity sensor 20 can include two units—one unit for generating a magnetic field and another with the reed switch and Bluetooth chip.

Still referring to FIG. 1, the seat sensing device 14 attached to the child car seat 12 can communicate with a GPS tracker 16 via a Bluetooth wireless connection 22. The proximity sensor 20 of the seat sensing device 14 can be activated whenever the child is buckled into the car seat 12. If the proximity sensor 20 is still activated when the vehicle's ignition is off, the seat sensing device 14 can send an alert via the Bluetooth connection 22 to the GPS tracker 16, which in turn can alert the user 28 that the child is still buckled in the car seat and can cause the camera 18 to capture an image and send it to the user. For example, the GPS tracker 16 can send a notifications to the user 28 via text or email stating “Child Car Seat was not unbuckled after stop” as well as camera images.

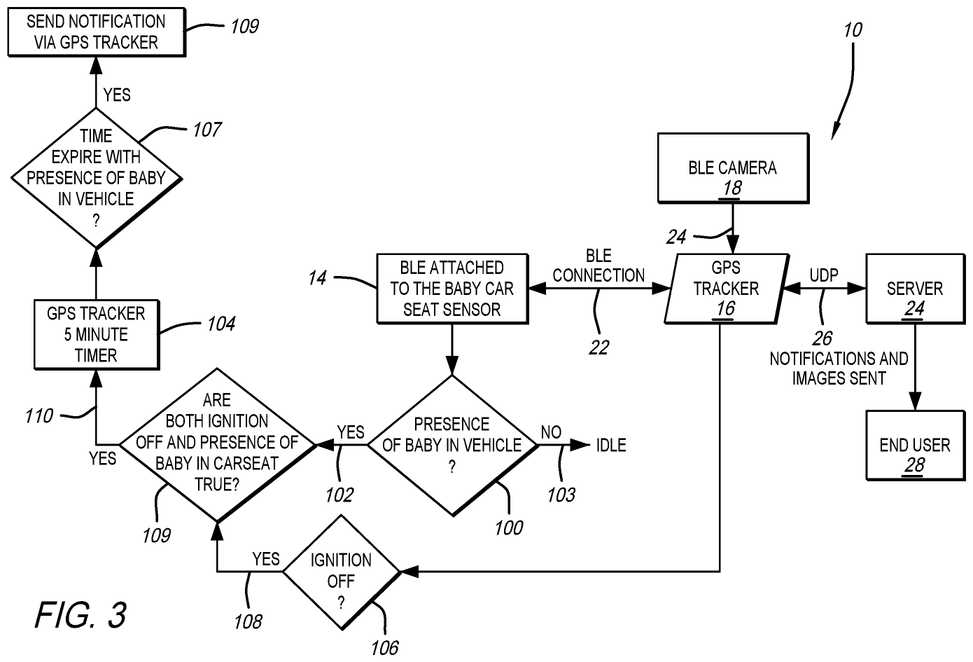

Referring to FIG. 3, the proximity sensors 20 can be activated whenever the child is buckled into the car seat 12.

If the proximity sensors 20 are still activated when the vehicle's ignition is off, the seat sensing device 14 can send an alert to the GPS tracker 16, which in turn can alert the user 28 that the child is still buckled in the car seat 12 and cause the camera 18 to capture an image and send it to the user 28. One vehicle security system utilizing an onboard camera to capture images of the interior of a car and that can sense when a vehicle's ignition is off is described in U.S. Pat. No. 10,597,000 to Avila entitled “Glass Break Sensor System,” which is incorporated by this reference as if set forth herein in its entirety.

As shown in FIG. 1, the onboard camera 18 can be in communication with a GPS tracker 16 in the vehicle (such as via a Bluetooth wireless connection 24). In one presently preferred embodiment, the GPS tracker 16 is a modular unit equipped with a processor, a GPS tracking component, a Bluetooth wireless (BLE) device, and a cellular modem. The GPS tracker 16 can receive power from the vehicle OBD connector, as described in U.S. Pat. No. 10,597,000 B2, entitled “Glass Break Sensor System,” which by this reference is incorporated into this specification as if fully set forth herein. The processor and BLE device can be part of a system-on-a-chip (SoC).

Referring to FIG. 3, in some embodiments, the GPS tracker 16 can access and communicate with a server 24 via the Internet 26. For example, the cellular modem of the GPS tracker 16 can be an LTE 4G modem that communicates with the server 24 over an LTE 4G mobile network using User Datagram Protocol (UDP). In this configuration, a user 28 can communicate with the server 24 using, a mobile device (not shown) via Wi-Fi or the 4G mobile network (whichever network the user 24 is using), and the server 24 can in turn communicate with the GPS tracker 16 over the LTE 4G network.

Still referring to FIG. 3, the proximity sensors 20 are activated when the child is buckled into the car seat 12. At step 102, this activation of the proximity sensors 20 serves to detect the presence of a child in the car seat 12 (step 100). If the proximity sensors are deactivated, such as by unbuckling the seat buckles, the system will be placed in an idle mode (step 103). Again referencing step 100, if the presence of a child is detected (step 102) and the processor of the GPS tracker 16 senses that the vehicle ignition is off (steps 106, 108), at steps 109-110 the GPS tracker 16 will start a timer 104 to allow a predetermined time for the child to be removed from the car seat 12. If the timer expires while the presence of the child in the seat is still detected (step 107), the GPS tracker 16 can send an alert to the user 28 (as well as to multiple other authorized contacts) (step 115) via the server 24 by email or text that the child is still buckled in the car seat and can cause the camera 18 to capture an image and send it to the user 28 and other authorized contacts.

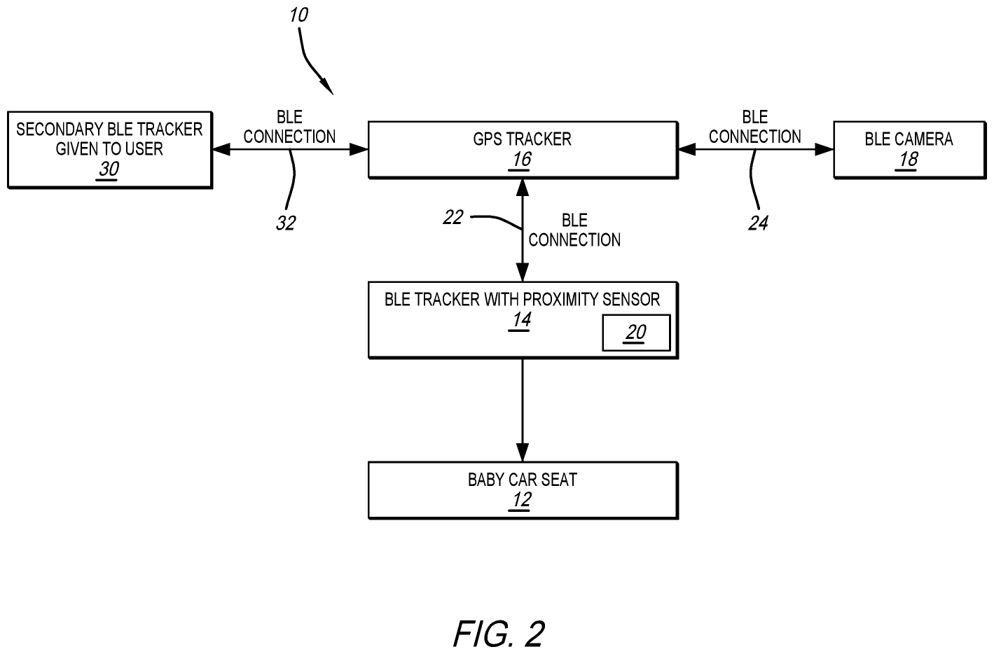

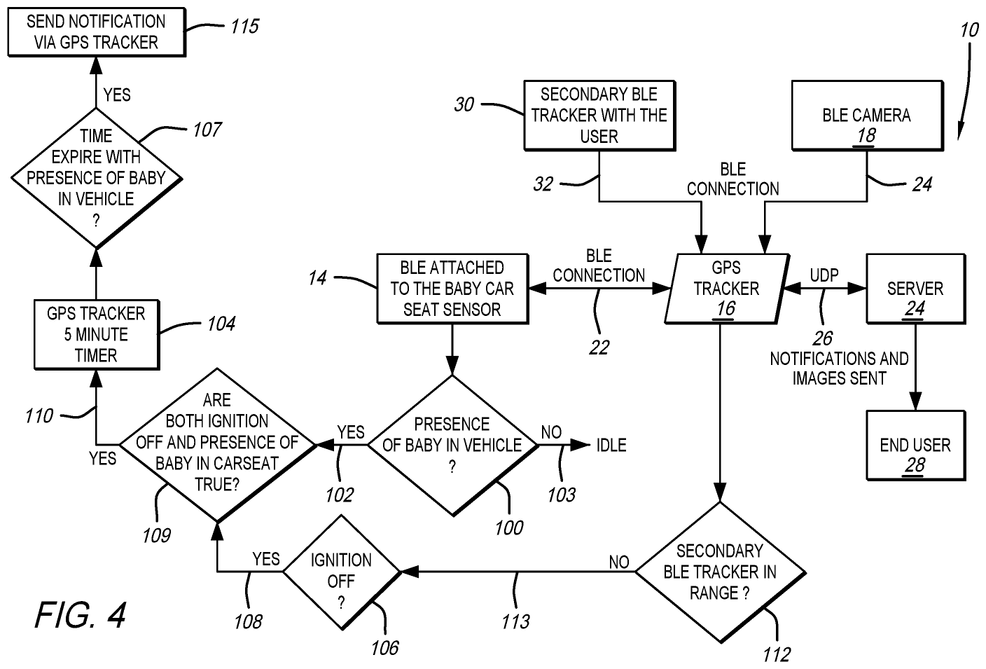

Referring to FIGS. 2 and 4, in some embodiments, the GPS tracker 16 can communicate wirelessly (such as via a Bluetooth wireless connection 32) with a secondary tracker 30 (i.e., tag) on the user 28 in addition to seat sensing device 14 attached to the child car seat 12. With this embodiment, the system will check whether the secondary tracker 30 is within a predefined range of the vehicle. If the GPS tracker 16 recognizes that the secondary tag 30 is outside of the predetermined range (steps 112-113), the system will proceed to step 106 and the subsequent steps described above, The Bluetooth wireless connection can be used to estimate the proximity of the secondary tracker 30 to the GPS tracker 16 by obtaining a measurement of the Received Signal Strength Indication (RSSI) for the secondary tracker 30, which can then be used to calculate an estimated distance between the two devices. In this way, the secondary tracker 30 can reduce false positives with the system so that the user 28 will not receive notifications when the vehicle's ignition is off but the user 28 is still in close proximity to the child in the car seat 12.

Upon reading this disclosure, additional advantages and modifications will readily occur to those skilled in the art. Therefore, the invention in its broader aspects is not limited to the specific details, representative devices, and illustrative examples shown and described. Accordingly, departures may be made from such details without departing from the spirit or scope of the general inventive concept.

What is claimed is:

1. A system for tracking a child car seat for a vehicle, the system comprising:
a seat sensing device including least one proximity sensor that can sense a child's presence in the car seat;
wherein the seat sensing device can communicate with a GPS tracker that can communicate with a camera onboard the vehicle;
wherein the seat sensing device is configured so that if the proximity sensor senses a child's presence in the car seat when the vehicle ignition is off, the seat sensing device will send an alert signal to the GPS tracker; and
wherein the GPS tracker is configured to cause the camera to capture an image of the car seat in the vehicle in response to the alert signal, and to send the image to the user.

2. The system of claim 1 wherein the proximity sensor is configured to detect whether a car seat buckle is fastened.

3. The system of claim 1 wherein GPS tracker can communicate wirelessly with a second tacking device in addition to the seat sensing device and wherein the second tracking device is in the possession of a user of the system.
